(19) United States
(12) Patent Application Publication
(10) Pub. No.: US 2012/0062812 A1
(43) Pub. Date: Mar. 15, 2012

(54) TRANSFLECTIVE LIQUID CRYSTAL DISPLAY PANEL

(76) Inventor: Bo-Rong Wu, Taichung County (TW)

(21) Appl. No.: 12/911,726

(22) Filed: Oct. 26, 2010

(30) Foreign Application Priority Data
Sep. 9, 2010 (TW) 099217486

(51) Int. Cl. G02F 1/1335; G02F 1/1368; G02F 1/1339

(52) U.S. Cl. 349/43

(57) ABSTRACT

A transflective liquid crystal display panel includes a color filter substrate and a thin film transistor array substrate having a transmissive region and a reflective region defined thereon, a liquid crystal layer positioned between the CF substrate and the TFT array substrate, and at least a conductive spacer positioned in between the CF substrate and the TFT array substrate. The CF substrate includes a color filter array, at least a pixel electrode and a common electrode positioned between the pixel electrode and the CF array. The common electrode is electrically isolated from the pixel electrode. The TFT array substrate includes at least a TFT having a gate, a source and a drain positioned in the transmissive region, and at least a reflector positioned in the reflective region. The conductive spacer electrically connects the pixel electrode positioned on the CF substrate to the drain positioned on the TFT array substrate.

### BACKGROUND OF THE INVENTION

1. Field of the Invention

The present invention is related to a transflective liquid crystal display (LCD), and more particularly, to a transflective in-plane switching (IPS) LCD.

2. Description of the Prior Art

LCDs can be classified into transmissive, reflective, and transflective based on the source of illumination. Along with the popularization of portable electronic products, the LCDs have to give consideration to the brightness of indoor ambient light and that of outdoor ambient light, which are different greatly from each other. Therefore the transflective LCD panel is developed to provide superior performance in abovementioned different environments.

Furthermore, it is well-known that the alignment direction of the liquid crystal (LC) molecules can be controlled by applying electric fields to the LC molecules. Therefore, LCDs also can be classified into twisted nematic (TN) mode, vertical alignment (VA) mode, and in-plane switching (IPS) mode based on the direction of the electric fields applied to the LC molecules. Among those modes, the IPS-LCD provides a wider viewing angle of about 160°.

Please refer to FIG. 1, which is a schematic drawing illustrating a conventional transflective IPS-LCD. As shown in FIG. 1, the conventional transflective IPS-LCD 100 includes a thin film transistor (TFT) array substrate 102, a color filter (CF) substrate 104 opposite to the TFT array substrate 102, and a liquid crystal (LC) layer positioned between the TFT array substrate 102 and the CF substrate 104. The LC layer includes a plurality of LC molecules 106. The conventional transflective IPS-LCD 100 also includes a plurality of pixel regions 110 and each of the pixel regions 110 includes a transmissive region 112 and a reflective region 114. A TFT (not shown) is positioned in each pixel region 110 defined on the TFT array substrate 102 and an insulating layer 130 covering the TFT is formed on the TFT array substrate 102. Furthermore, the insulating layer 130 in the reflective region 114 includes a predetermined concave-convex pattern formed by a photomask. A reflective layer 140 is formed on the insulating layer 130 in the reflective region 114 and thus the reflective layer 140 obtains a rough surface profile along the concave-convex pattern of the insulating layer 130. By forming the rough surface of the reflective layer 140, the reflectivity is improved. A pixel electrode 150 comprising transparent conductive material is formed and electrically connected to the TFT through a contact hole (not shown) in the insulating layer 130.

Please refer to FIG. 2, which is a schematic diagram illustrating lines of electric force in a portion of pixel region of the conventional transflective IPS-LCD. It is noteworthy, the conventional transflective IPS-LCD 100 further includes a common electrode 152 positioned on the TFT array substrate 102. The common electrode 152 and the pixel electrode 150 respectively include a comb-teeth (not shown) that are mutually interlaced and electrically isolated from each other by another insulating layer 132. It is well-known to those skilled in the art that when voltages are respectively applied to the pixel electrode 150 and the common electrode 152, electric fields parallel with the TFT array substrate 102 and the CF substrate 104 are generated, and consequently the LC molecules 106 are directed to be parallel with the TFT array substrate 102 for controlling the transmittance of lights.

It is noteworthy that due to the concave-convex pattern of the insulating layer 130, the common electrode 152, the reflective layer 140 and the insulating layer 132 formed on the insulating layer 130 in the reflective region 114 of the TFT array substrate 102 all obtain the rough surface profile along the concave-convex pattern. Consequently, the pixel electrode 150 on the insulating layer 132 is formed to have different tilt angles as shown in FIG. 2. Accordingly, the electric fields in the transmissive region 112 are parallel with the TFT array substrate 102 and the CF substrate 104 as predetermined and required, and the LC molecules 106 are arranged to be parallel with the TFT array substrate 102 and the CF substrate 104. However, the electric fields in the reflective region 114 interfere with each other due to the common electrode 152 and the pixel electrode 150 having the abovementioned tile angles. Consequently, the LC molecules 106 are not arranged parallel with the TFT array substrate 102 and the CF substrate 104 as predetermined and required. Therefore the transmittance of light in the reflective region 114 is adversely impacted. In other words, the rough surface of reflective layer 140 in the reflective region 114 improves the reflectivity but deteriorates the transmittance in the reflective region 114. Accordingly, the brightness in the transmissive region 112 and the reflective region 114 of a single pixel region 110 is not uniform.

Therefore, it is still in need to have a transflective IPS-LCD having the rough surface for improving the reflectivity in the reflective region without adversely impacting the electrical field distribution and the transmittance in the reflective region.

### SUMMARY OF THE INVENTION

Therefore, the present invention provides a transflective IPS-LCD having improved reflectivity without adversely impacting the electrical field distribution.

According to an aspect of the present invention, a transflective LCD is provided. The transflective LCD includes a color filter (CF) substrate having a transmissive region and a reflective region defined thereon, a thin film transistor (TFT) substrate having the transmissive region and the reflective region defined thereon, a liquid crystal (LC) layer sandwiched in between the CF substrate and the TFT array substrate, and at least a conductive spacer positioned in between the CF substrate and the TFT array substrate. The CF substrate further includes a color filter array, at least a pixel electrode, and at least a common electrode positioned between the color filter array and the pixel electrode. The common electrode is electrically isolated from the pixel electrode. The TFT array substrate further includes at least a TFT positioned in the transmissive region and at least a reflector positioned in the reflective region. The TFT includes a gate, a source and a drain. The conductive spacer positioned in between the CF substrate and the TFT array substrate is electrically connected to the drain and the pixel electrode.

According to the transflective IPS-LCD provided by the present invention, the reflector having the rough surface for improving reflectivity is formed on the TFT array substrate while the common electrode and the pixel electrode for generating the electric fields are formed on the CF substrate. Therefore, the common electrode and the pixel electrode are not impacted by the rough surface of the reflector. Accordingly, the electric fields generated by the common electrode and the pixel electrode are always parallel with the CF substrate and the TFT array substrate in both of the transmissive region and the reflective region. Consequently, the transflective IPS-LCD provided by the present invention simultaneously improves the reflectivity and the transmittance, and thus a transflective IPS-LCD providing an uniform brightness is obtained.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating a conventional transflective IPS-LCD;

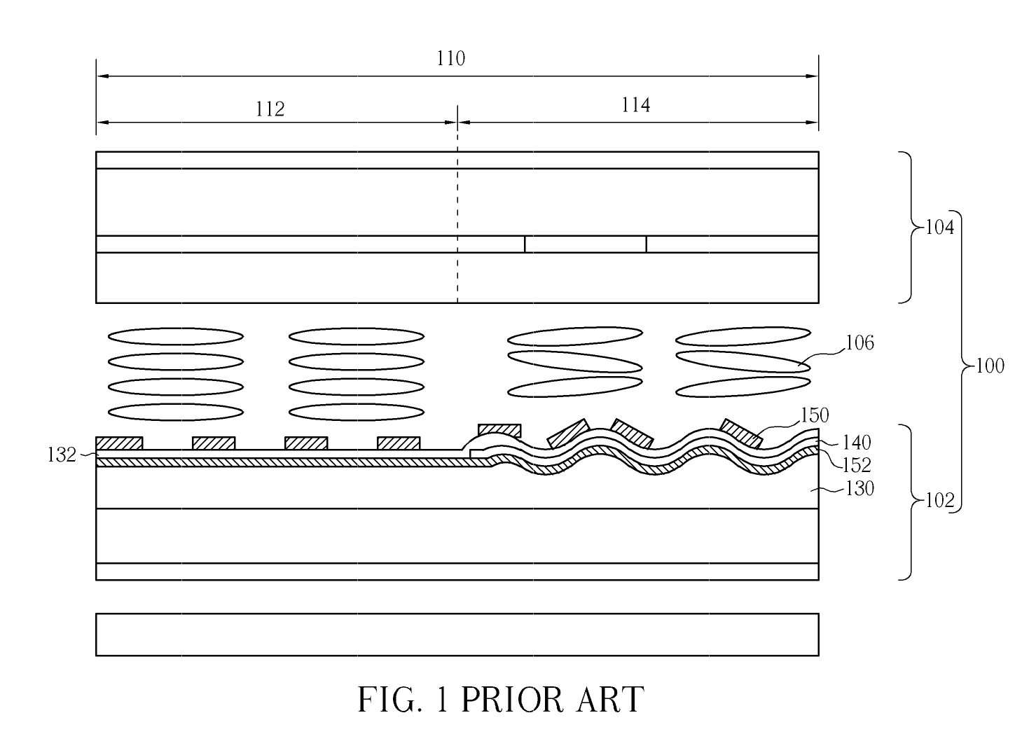

FIG. 2 is a schematic diagram illustrating lines of electric force in a portion of pixel region of the conventional transflective IPS-LCD;

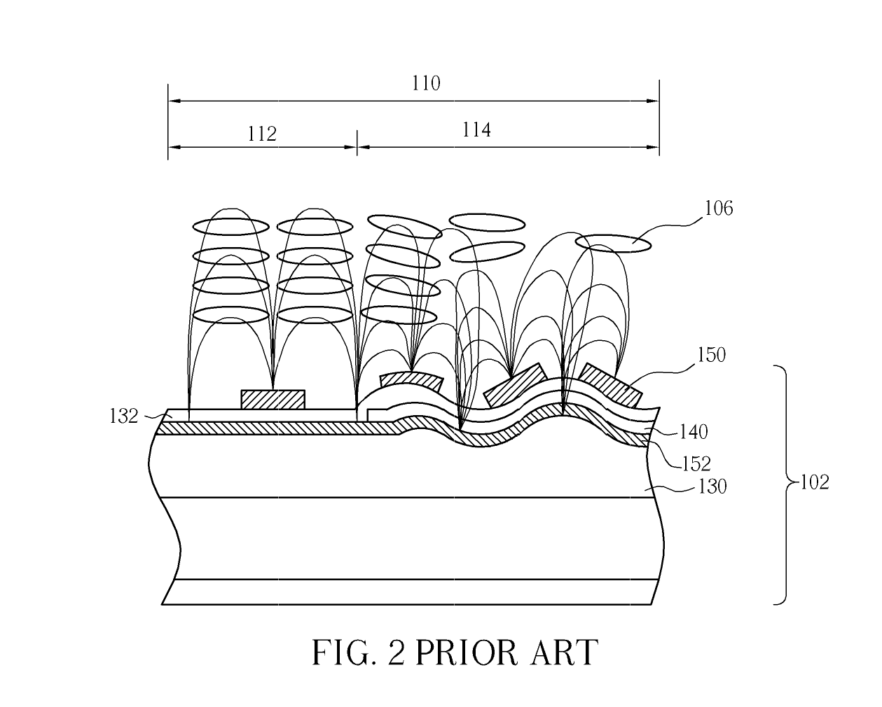

FIG. 3 is a schematic drawing illustrating a transflective IPS-LCD provided by a preferred embodiment of the present invention; and

FIG. 4 is a schematic diagram illustrating lines of electric force in a portion of the transflective IPS-LCD provided by the preferred embodiment.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

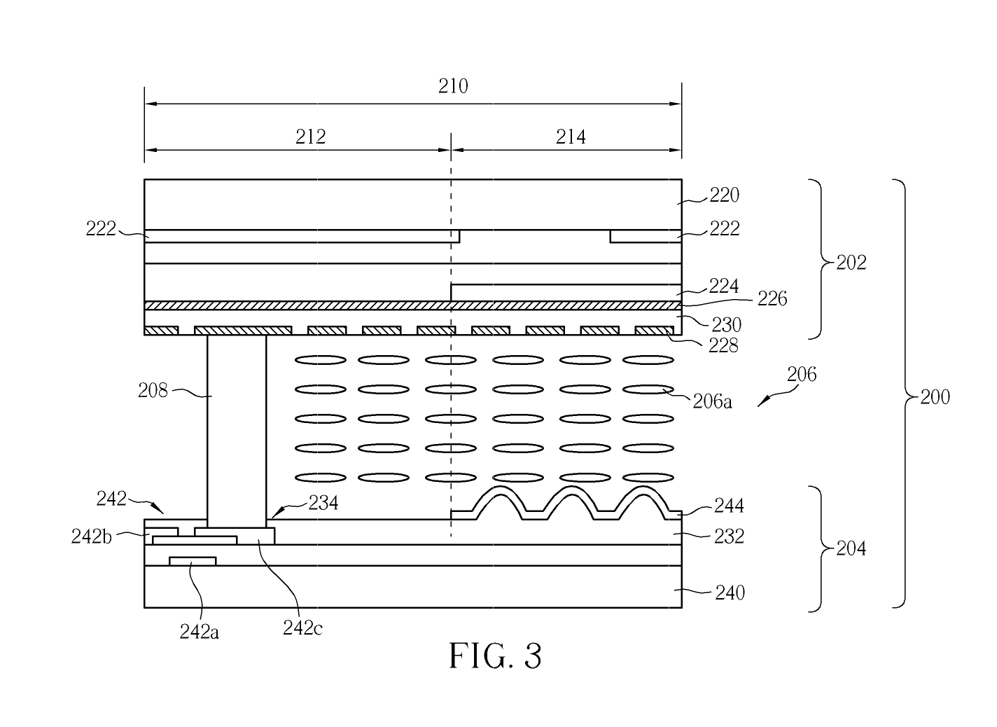

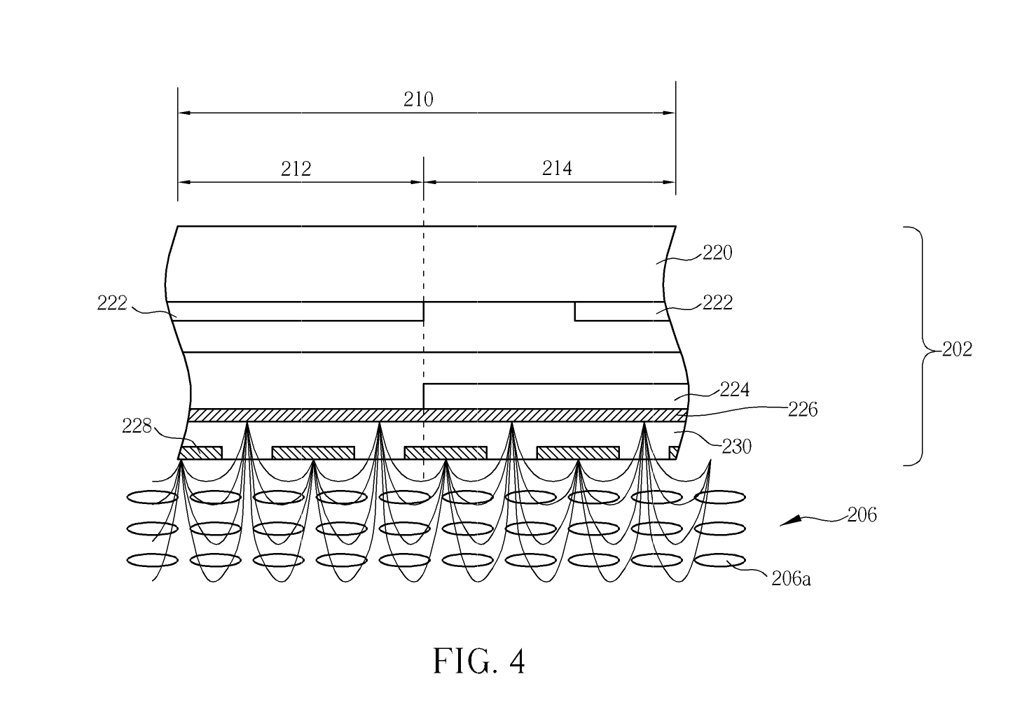

Please refer to FIG. 3 and FIG. 4, wherein FIG. 3 is a schematic drawing illustrating a transflective IPS-LCD provided by a preferred embodiment of the present invention and FIG. 4 is a schematic diagram illustrating lines of electric force in a portion of the transflective IPS-LCD provided by the preferred embodiment. As shown in FIG. 3, the transflective IPS-LCD 200 provided by the present invention includes a color filter (CF) substrate 202, a TFT array substrate 204, and a liquid crystal (LC) layer 206 sandwiched in between the CF substrate 202 and the TFT array substrate 204. The LC layer 206 includes a plurality of LC molecules 206a. It is noteworthy that in the preferred embodiment, the CF substrate 202 and the TFT array substrate 204 of the transflective IPS-LCD 200 both have a plurality of pixel regions 210 respectively including a transmissive region 212 and a reflective region 214 defined thereon.

Please refer to FIG. 3 again. The CF substrate 202 includes a transparent substrate 220 and a color filter array 222 positioned on the transparent substrate 220 at the side facing the TFT array substrate 204. Those skilled in the art would easily realize a variety of the color filter array 222 architecture usually based on different combinations of primary colors (red, green, blue), complementary colors (cyan, magenta, yellow), or white can be chosen. Since the color filter array 222 architecture and patterns are well-known to those skilled in the art, those details are omitted herein in the interest of brevity. As shown in FIG. 3, cell gaps in the transmissive region 212 and the reflective region 214 of the transflective IPS-LCD 200 of the preferred embodiment are substantially the same, but not limited to this. The cell gap in the reflective region 214 can be a half of the cell gap of the transmissive region 212 in the preferred embodiment. Additionally, since the cell gaps in the transmissive region 212 and the reflective region 214 are the same in the preferred embodiment, phase retardations and brightness values are accordingly different in the transmissive region 212 and the reflective region 214. As a countermeasure against to the problems, an in-cell retarder 224 is formed on the CF substrate 202 in the reflective region 214 according to the preferred embodiment. The CF substrate 202 of the preferred embodiment further includes a common electrode 226 formed on the CF substrate 202. The common electrode 226 can include transparent metal oxide material such as Indium Tin Oxide (ITO) or Indium Zinc Oxide (IZO). In the preferred embodiment, a first insulating layer 230 is formed on the common electrode 226 and at least a pixel electrode 228 is formed on the first insulating layer 230. The pixel electrode 228 also can include ITO or IZO. As shown in FIG. 3, the common electrode 226 is positioned in between the color filter array 222 and the pixel electrode 228 in a direction vertical to the CF substrate 202, and the common electrode 226 is electrically isolated from the pixel electrode 228 by the first insulating layer 230. The common electrode 226 and the pixel electrode 228 respectively include a comb-teeth (not shown) that are mutually interlaced, but not limited to this.

Please still refer to FIG. 3. The TFT array substrate 204 includes a transparent substrate 240 having a plurality of scan lines and data lines (not shown) arranged in crossover. And at least a TFT 242 serving as the switch device for a pixel is positioned at each of intersections of the scan lines and the data lines. As mentioned above, the TFT array substrate 204 also includes the transmissive region 212 and the reflective region 214 defined thereon. In the preferred embodiment, at least a reflector 244 is positioned in the reflective region 214 and the TFT 242 is positioned in the transmissive region 212. However, it is not limited to form the TFT 242 in the reflective region 214 if required. As those skilled in the art know, the TFT 242 further includes a gate 242a, a source 242b and a drain 242c. Furthermore, a second insulating layer 232 covering the TFT 242 is formed on the TFT array substrate 204 both in the transmissive region 212 and the reflective region 214. The second insulating layer can be an organic insulating layer, but not limited to this. And the reflector 244 is positioned on the second insulating layer 232. For improving reflectivity in the reflective region 214, the second insulating layer 232 is patterned to have a predetermined concave-convex pattern by a photomask having a predetermined pattern, and the reflector 244 formed on the second insulating layer 232 obtains a rough surface along the predetermined concave-convex pattern of the second insulating layer 232 in the reflective region 214. In addition, the second insulating layer 232 includes a contact hole 234 for exposing the drain 242c of the TFT 242 in the transmissive region 212.

The gate 242a of the TFT 242 is electrically connected to the scan line and the source 242b is electrically connected to the data line. It is noteworthy that a conductive spacer 208 is positioned in between the CF substrate 202 and the TFT array substrate 204 in the preferred embodiment. The conductive spacer 208 is electrically connected to the drain 242c positioned on the TFT array substrate 204 through the contact hole 234 in the second insulating layer 232 and to the pixel electrode 228 positioned on the CF substrate 202. The conductive spacer 208 includes conductive material such as Al, Ag, or AlNd, but not limited to this. Furthermore, the conductive spacer 208 can include an insulating material and a conductive layer coating on the insulating material.

Please refer to FIG. 3 and FIG. 4. According to the transflective IPS-LCD 200 provided by the preferred embodiment, the pixel electrode 228 and the common electrode 226 are positioned on the CF substrate 202, instead of on the TFT array substrate 204 while the TFT 242 serving as the switch device is still positioned on the TFT array substrate 204. It is noteworthy that the drain 242c of the TFT 242 is electrically connected to the pixel electrode 228 by the conductive spacer 208 that is positioned in between the CF substrate 202 and the TFT array substrate 204. Accordingly, signal transmission between the drain 242c and the pixel electrode 228 is not impacted at all. Furthermore, the reflectors 244 in each of the reflective regions 214 still obtain the rough surface for improving reflectivity by forming along the concave-convex pattern of the second insulating layer 232. More important, since the pixel electrode 228 and the common electrode 226 are positioned on the CF substrate 202 having the even surface, when the voltages are respectively applied to the common electrode 226 and the pixel electrode 228, the generated electric fields are always parallel with the CF substrate 202 and the TFT array substrate 204 without affecting each other as shown in FIG. 4. Consequently, the LC molecules 206a in the LC layer 206 are arranged parallel with the CF substrate 202 and the TFT array substrate 204 both in the transmissive region 212 and the reflective region 214 as desired and required. Thus the same transmittances in both of the transmissive region 212 and the reflective region 214 are achieved.

As mentioned above, according to the transflective IPS-LCD provided by the present invention, the reflector having the rough surface for improving the reflectivity is formed on the TFT array substrate while the common electrode and the pixel electrode for generating the electric fields are formed on the CF substrate. Therefore, the common electrode and the pixel electrode are not impacted by rough surface of the reflector. Accordingly, the electric fields generated by the common electrode and the pixel electrode are always parallel with the CF substrate and the TFT array substrate in both of the transmissive region and the reflective region. Furthermore, by providing the conductive spacer in between the CF substrate and the TFT array substrate, the electrical connection and the signal transmission between the pixel electrode and the TFT are still constructed. Consequently, the transflective IPS-LCD provided by the present invention simultaneously improves the reflectivity and the transmittance, and thus a transflective IPS-LCD having an uniform brightness is obtained.

Those skilled in the art will readily observe that numerous modifications and alterations of the device and method may be made while retaining the teachings of the invention.

What is claimed is:

1. A transflective liquid crystal display (LCD) comprising:
a color filter (CF) substrate having a transmissive region and a reflective region defined thereon, the CF substrate further comprising:
a color filter array;
at least a pixel electrode; and
a common electrode positioned between the color filter array and the pixel electrode, the common electrode being electrically isolated from the pixel electrode;
a thin film transistor (TFT) array substrate having the transmissive region and the reflective region defined thereon, the TFT array substrate further comprising:
at least a thin film transistor positioned in the transmissive region, the thin film transistor having a gate, a source and a drain; and
at least a reflector positioned in the reflective region;
a liquid crystal (LC) layer sandwiched in between the CF substrate and the TFT array substrate; and
at least a conductive spacer positioned in between the CF substrate and the TFT array substrate and electrically connected to the drain and the pixel electrode.

2. The transflective LCD of claim 1, further comprising a first insulating layer electrically isolating the common electrode from the pixel electrode formed on the color filter array.

3. The transflective LCD of claim 1, further comprising a second insulating layer formed on the TFT array substrate in the transmissive region and the reflective region.

4. The transflective LCD of claim 3, wherein the second insulating layer in the reflective region comprises a rough surface.

5. The transflective LCD of claim 4, wherein the reflector is positioned on the rough surface of the second insulating layer.

6. The transflective LCD of claim 3, wherein the second insulating layer further comprises a contact hole exposing the drain in the transmissive region, and the conductive spacer is electrically connected to the drain and the pixel electrode through the contact hole.

7. The transflective LCD of claim 1, further comprising an in-cell retarder positioned in the reflective region in the CF substrate.

8. The transflective LCD of claim 1, wherein the conductive spacer comprises a conductive material.

9. The transflective LCD of claim 8, wherein the conductive material comprises Al, Ag or AlNd.

10. The transflective LCD of claim 1, wherein the conductive spacer comprises an insulating material and a conductive layer coating on the insulating material.
